(19) United States
(12) Patent Application Publication
(10) Pub. No.: US 2026/0112949 A1
(43) Pub. Date: Apr. 23, 2026

(54) LAMINATED BODY MANUFACTURING DEVICE AND LAMINATED BODY MANUFACTURING METHOD

(71) Applicant: NHK SPRING CO., LTD., Yokohama-shi, Kanagawa (JP)

(72) Inventor: Michinobu HIRAMA, Yokohama-shi, Kanagawa (JP)

(21) Appl. No.: 19/116,726

(22) PCT Filed: Sep. 28, 2023
(86) PCT No.: PCT/JP2023/035507

§ 371 Date: Mar. 28, 2025

(30) Foreign Application Priority Data
Sep. 30, 2022 (JP) 2022-158220

(51) Int. Cl. H02K 15/0273; B32B 7/08; B32B 15/01; H02K 15/40

(52) U.S. Cl. CPC H02K 15/0273; B32B 7/08; B32B 15/011; H02K 15/40; B32B 2250/05

(57) ABSTRACT

A laminated body manufacturing device includes a feed mechanism, a receiving member, a dividing mechanism and a squeeze. The feed mechanism is capable of feeding plural iron core members including locking iron core members and non-locking iron core members. The locking iron core members have locking pieces at an outer periphery or inner periphery thereof, and the non-locking iron core members do not have the locking pieces. The receiving member is capable of receiving the iron core members fed from the feed mechanism. The dividing mechanism is disposed between the feed mechanism and the receiving member and controls feeding of the iron core members to the receiving member. The squeeze is disposed between the feed mechanism and the dividing mechanism and laterally supports the iron core members fed from the feed mechanism. At least one of the iron core members is composed as a block body

### TECHNICAL FIELD

The present disclosure relates to a laminated body manufacturing device and a laminated body manufacturing method.

### BACKGROUND ART

A motor core (a rotor core or a stator core) is used in a motor mounted in an electric car or the like. Manufacturing laminated bodies in which plural iron core members are laminated in order to produce a motor core has been known since heretofore.

Japanese Patent Application Laid-Open (JP-A) No. 2019-118169 recites using a plate laminating device to manufacture laminated bodies that are to constitute a stator core. In this plate laminating device, a sensor and a dividing mechanism are provided in the vicinity of an exit aperture of a cylinder that serves as a conveyance path. The sensor detects the passing of plates being discharged from the cylinder, and the dividing mechanism supports the plates. In accordance with detection results from the sensor, the dividing mechanism projects into the conveyance path of the plates at arbitrary timings to pause the conveyance, thus controlling numbers and timings of feeding of the plates to a jig.

### SUMMARY OF INVENTION

### Technical Problem

When, as in JP-A No. 2019-118169, projection timings of a dividing mechanism are determined only on the basis of detection results from a sensor detecting the passing of plates discharged from a cylinder, if a plate discharge speed from the cylinder is relatively fast, a duration from detecting the passing of a plate to completing operation of the dividing mechanism needs to be extremely short. Accordingly, specialist equipment with high response speeds is required for an actuator of the dividing mechanism, the sensor and a control device thereof, and a level of difficulty of control rises. Further, if an operation speed of the dividing mechanism declines due to, for example, aging of the actuator of the dividing mechanism or the like, a plate whose conveyance should be paused may reach a location at which the dividing mechanism is provided before operation of the dividing mechanism is complete, and a failure may occur in which conveyance of that plate cannot be paused. Further yet, in order to operate the dividing mechanism precisely, aging of the actuator of the dividing mechanism and such must be checked frequently, and a frequency of maintenance needs to be high.

In consideration of the problem described above, an object of the present disclosure is to provide a laminated body manufacturing device and a laminated body manufacturing method that may laminate iron core members accurately and efficiently without requiring specialist equipment or the like.

### Solution to Problem

In order to achieve the object described above, a laminated body manufacturing device according to a first aspect of the present disclosure includes: a feed mechanism capable of feeding plural iron core members including a locking iron core member and a non-locking iron core member, the locking iron core member including locking pieces at plural locations of an outer periphery or inner periphery thereof, and the non-locking iron core member not including the locking pieces; a receiving member capable of receiving the iron core members fed from the feed mechanism; a dividing mechanism disposed between the feed mechanism and the receiving member in a conveyance direction of the iron core members, the dividing mechanism controlling feeding of the iron core members to the receiving member; and a squeeze disposed between the feed mechanism and the dividing mechanism in the conveyance direction, the squeeze laterally supporting the iron core members being fed from the feed mechanism, and the squeeze being capable of conveying the iron core members laterally supported by the squeeze in the conveyance direction inside the squeeze, wherein: at least one of the iron core members is composed as a block body in which plural plate-shaped core pieces are bonded to one another; and the dividing mechanism includes locking parts that are movable between a locking position, at which the locking parts respectively lock the plural locking pieces of the locking iron core member discharged from the squeeze, and a non-locking position, at which the locking parts respectively do not lock the locking pieces, and an actuating device that moves the locking parts to the locking position and the non-locking position.

In the laminated body manufacturing device described above, because the dividing mechanism locks the locking pieces of a locking iron core member, a period in which a non-locking iron core member passes through a location at which the dividing mechanism is provided may be utilized as a period for moving the locking parts of the dividing mechanism to the locking position. Therefore, the iron core members may be supported reliably by the dividing mechanism, and lamination of the iron core members may be conducted accurately.

In a laminated body manufacturing device according to a second aspect of the present disclosure, in the laminated body manufacturing device according to the first aspect of the present disclosure, the iron core members are plurally laminated and compose a block core, one or a laminated plural number of the block core composes a motor core, and the block core includes one or a plural number of the locking iron core member disposed at a downstream side in the conveyance direction and one or a plural number of the non-locking iron core member disposed at the upstream side in the conveyance direction.

In the laminated body manufacturing device described above, because the locking iron core members are at the downstream side among the plural iron core members composing each block core, the block cores may be individually divided by the dividing mechanism.

In a laminated body manufacturing device according to a third aspect of the present disclosure, in the laminated body manufacturing device according to the second aspect of the present disclosure, after the actuating device has moved the locking parts from the locking position to the non-locking position, the actuating device returns the locking parts to the locking position in a period in which the non-locking iron core member is passing through a location on the conveyance path of the iron core members that encompasses the locking position.

In the laminated body manufacturing device described above, the dividing mechanism may conduct the return operation, from the non-locking position to the locking position for locking the plural iron core members that are to compose the next block core, during the period in which the non-locking iron core member is passing through the location at which the dividing mechanism is provided. Therefore, a duration for conducting the return operation that is longer than in conventional technologies may be assured.

In a laminated body manufacturing device according to a fourth aspect of the present disclosure, in the laminated body manufacturing device according to any one of the first to third aspects of the present disclosure, fastening portions are provided at the plural core pieces composing the block body and the fastening portions are used for the bonding of the block body.

In the laminated body manufacturing device described above, the core pieces may be bonded to one another easily by laminating and pressing the core pieces at which the fastening portions are formed.

In a laminated body manufacturing device according to a fifth aspect of the present disclosure, the laminated body manufacturing device according to any one of the first to fourth aspects of the present disclosure further includes a rotating mechanism that rotates the receiving member about a rotation axis along the conveyance direction.

In the laminated body manufacturing device described above, stack rotation (rotational lamination) of the individual block cores may be conducted.

A laminated body manufacturing device according to a sixth aspect of the present disclosure includes: a squeeze capable of conveying plural iron core members including a locking iron core member and a non-locking iron core member downward, the locking iron core member including locking pieces at plural locations of an outer periphery thereof, and the non-locking iron core member not including the locking pieces; a feed mechanism disposed at an upstream side of the squeeze in a conveyance direction of the iron core members, the feed mechanism being capable of selectively feeding the locking iron core member and the non-locking iron core member to the squeeze; and a receiving member capable of receiving the iron core members fed from an end portion at the downstream side of the squeeze in the conveyance direction, wherein: at least one of the iron core members is composed as a block body in which plural plate-shaped core pieces are bonded to one another; and the squeeze includes a squeeze upstream portion disposed at the upstream side of the squeeze in the conveyance direction and a squeeze downstream portion disposed at the downstream side of the squeeze in the conveyance direction, the squeeze upstream portion laterally supporting a plural number of the locking iron core member and non-locking iron core member passing through the interior of the squeeze, and the squeeze downstream portion laterally supporting the locking pieces of the locking iron core member passing through the interior of the squeeze.

The laminated body manufacturing device described above may adjust timings and numbers of feeding of the iron core members to the receiving jig without using a dedicated mechanism that is capable of temporarily retaining the iron core members discharged from the squeeze, meaning the dividing mechanism, a retaining mechanism or the like. Moreover, because durations for substitution and stack rotation or the like of the receiving jig may be assured, the laminated bodies may be manufactured efficiently without pausing the device.

A laminated body manufacturing method according to a seventh aspect of the present disclosure includes: bonding plural plate-shaped core pieces to one another to form a block body; feeding plural iron core members from a feed mechanism, at least one of the iron core members being composed as the block body, and the plural iron core members including a locking iron core member and a non-locking iron core member, the locking iron core member including locking pieces at plural locations of an outer periphery or inner periphery thereof, and the non-locking iron core member not including the locking pieces; laterally supporting the iron core members fed from the feed mechanism, including using a squeeze disposed at the downstream side of the feed mechanism in a conveyance direction of the iron core members, the squeeze being capable of conveying the iron core members laterally supported by the squeeze in the conveyance direction inside the squeeze; selectively supporting the iron core members discharged from the squeeze, including using a dividing mechanism that includes locking parts that are movable between a locking position, at which the locking parts respectively lock the plural locking pieces of the locking iron core member discharged from the squeeze, and a non-locking position, at which the locking parts respectively do not lock the locking pieces, and an actuating device that moves the locking parts to the locking position and the non-locking position, the locking parts disposed at the locking position locking the locking pieces of the locking iron core member for supporting the iron core members; moving the locking parts from the locking position to the non-locking position for feeding a plural number of the iron core members supported by the dividing mechanism to a receiving member; and returning the locking parts that have been moved to the non-locking position to the locking position in a period in which the non-locking iron core member is passing through a location on the conveyance path of the iron core members that encompasses the locking position.

In the laminated body manufacturing method described above, because the locking parts of the dividing mechanism touch the locking pieces of the locking iron core member, a period in which the non-locking iron core member passes through the location at which the dividing mechanism is provided may be utilized as a period for moving the locking parts from the non-locking position to the locking position. Therefore, a duration for movement of the locking parts that is longer than in conventional technologies may be assured. Further, because the block body formed by bonding the plural number of core pieces is employed for at least some of the iron core members, the iron core members are unlikely to deform during conveyance, and conveyance attitudes of the iron core members during conveyance are stable.

In a laminated body manufacturing method according to an eighth aspect of the present disclosure, the laminated body manufacturing method according to the seventh aspect of the present disclosure further includes rotating the receiving member by a predetermined angle about a rotation axis along the conveyance direction.

In the laminated body manufacturing method described above, stack rotation of the individual block cores may be conducted.

In a laminated body manufacturing method according to a ninth aspect of the present disclosure, in the laminated body manufacturing method according to the seventh or eighth aspect of the present disclosure, the iron core members are plurally laminated and compose a block core, one or a laminated plural number of the block core composes a motor core, and the block core includes one or a plural number of the locking iron core member disposed at a downstream side in the conveyance direction of the block core and one or a plural number of the non-locking iron core member disposed at the upstream side in the conveyance direction.

In the laminated body manufacturing method described above, the dividing mechanism may conduct the return operation, from the non-locking position to the locking position that locks the plural iron core members that are to compose the next block core, during the period in which the non-locking iron core member is passing the location at which the dividing mechanism is provided. Therefore, a duration for conducting the return operation that is longer than in conventional technologies may be assured.

A laminated body manufacturing method according to a tenth aspect of the present disclosure includes: bonding plural plate-shaped core pieces to one another to form a block body; feeding plural iron core members to a squeeze, at least one of the iron core members being composed as the block body, the plural iron core members including a locking iron core member and a non-locking iron core member, the locking iron core member including locking pieces at plural locations of an outer periphery thereof, and the non-locking iron core member not including the locking pieces, and the squeeze including a squeeze upstream portion disposed at the upstream side of the squeeze in the conveyance direction of the iron core members and a squeeze downstream portion disposed at the downstream side of the squeeze in the conveyance direction, the squeeze upstream portion laterally supporting a plural number of the locking iron core member and non-locking iron core member passing through the interior of the squeeze, and the squeeze downstream portion laterally supporting the locking pieces of the locking iron core member passing through the interior of the squeeze; and receiving, at a receiving member, the locking iron core member that has passed through the squeeze downstream portion or the locking iron core member that has passed through the squeeze downstream portion and one or a plural number of the non-locking iron core member supported at an upper face of the locking iron core member.

The laminated body manufacturing method described above may adjust timings and numbers of feeding of the iron core members to the receiving jig without using a dedicated mechanism that is capable of temporarily retaining the iron core members discharged from the squeeze, meaning the dividing mechanism, a retaining mechanism or the like. Therefore, durations for substituting the receiving jig and stack rotation or the like may be assured.

According to the laminated body manufacturing device and laminated body manufacturing method of the present disclosure, lamination of iron core members may be conducted accurately and efficiently without requiring specialist equipment or the like.

### BRIEF DESCRIPTION OF DRAWINGS

FIG. 1A is a plan view showing an example of a locking iron core member to be fed to a laminated body manufacturing device according to a first exemplary embodiment of the present disclosure.

FIG. 1B is a sectional diagram cut along line A-A in FIG. 1A.

FIG. 2A is a plan view showing an example of a non-locking iron core member to be fed to the laminated body manufacturing device according to the first exemplary embodiment of the present disclosure.

FIG. 2B is a sectional diagram cut along line B-B in FIG. 2A.

FIG. 3 is a schematic descriptive diagram showing an example of the laminated body manufacturing device according to the first exemplary embodiment of the present disclosure.

FIG. 4 is a schematic sectional diagram cut along line C-C in FIG. 3.

FIG. 5 is a schematic sectional diagram cut along line D-D in FIG. 3.

FIG. 6 is a flowchart showing an example of a laminated body manufacturing method according to the first exemplary embodiment of the present disclosure.

FIG. 7A is an operation description diagram showing principal parts of the manufacturing device when the laminated body manufacturing method illustrated in FIG. 6 is performed.

FIG. 7B is an operation description diagram showing principal parts of the manufacturing device when the laminated body manufacturing method illustrated in FIG. 6 is performed.

FIG. 7C is an operation description diagram showing principal parts of the manufacturing device when the laminated body manufacturing method illustrated in FIG. 6 is performed.

FIG. 8 is a schematic descriptive diagram showing an example of a laminated body manufacturing device according to a second exemplary embodiment of the present disclosure.

FIG. 9 is a schematic sectional diagram cut along line E-E in FIG. 8.

FIG. 10 is a flowchart showing an example of a laminated body manufacturing method according to the second exemplary embodiment of the present disclosure.

FIG. 11A is an operation description diagram showing principal parts of the manufacturing device when the laminated body manufacturing method illustrated in FIG. 10 is performed.

FIG. 11B is an operation description diagram showing principal parts of the manufacturing device when the laminated body manufacturing method illustrated in FIG. 10 is performed.

FIG. 11C is an operation description diagram showing principal parts of the manufacturing device when the laminated body manufacturing method illustrated in FIG. 10 is performed.

### DESCRIPTION OF EMBODIMENTS

This application is based on Patent Application No. 2022-158220 filed in Japan on Sep. 30, 2022, the contents of which form a part of the contents of this application.

The present disclosure will be more fully understood from the following detailed descriptions. Scope of application of the present application will become more apparent from the detailed descriptions below. However, the detailed descriptions and specific examples are preferred embodiments of the present disclosure and are described for the purpose of explanation only. From these detailed descriptions, numerous changes and modifications within the spirit and scope of the present disclosure will be apparent to those skilled in the art.

The applicants have no intention of dedicating any of the described embodiments to the public; all disclosed modifications and alternatives, including those that may not literally fall within the scope of the claims, are intended to be part of the invention under the doctrine of equivalents.

Below, exemplary embodiments for carrying out the present disclosure are described with reference to the drawings. A scope required for explanation to achieve the object of the present disclosure is illustrated in a schematic manner. Scopes required for explanation of the relevant parts of the present disclosure are principally explained, and parts for which explanations are omitted will be based on publicly known technology. The same or similar reference symbols are used for members that are the same or equivalent in the drawings, and duplicative descriptions are omitted. Where plural members that are the same as or equivalent to one another are included in the drawings, reference symbols may be attached to only some of those members in order to aid viewing of the drawings.

### First Exemplary Embodiment

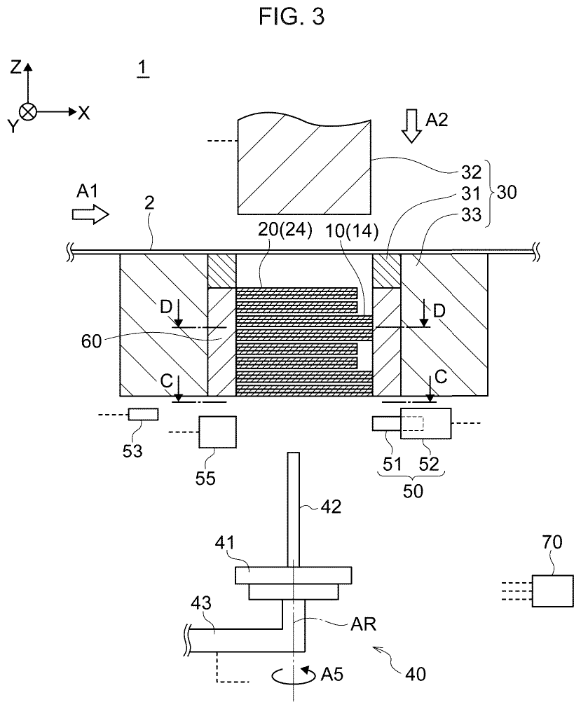

Before a laminated body manufacturing device 1 (see FIG. 3) and laminated body manufacturing method according to the first exemplary embodiment are described, iron core members that compose the laminated bodies are briefly described. In the present exemplary embodiment, the laminated iron core members are plurally laminated to compose block cores, and one or a plural number of these block cores may be laminated to compose a motor core, for example, a stator core of an inner rotor-type rotary electric machine. In the present disclosure, the meaning of the term “laminated body” is intended to include a body in which plural iron core members are individually laminated, and a body in which these laminated bodies are welded is referred to as a “motor core”, distinguishing the two bodies. The above-mentioned motor core may be either of a segmented stator core and a non-segmented stator core, or may constitute a rotor core that is not a stator core.

The iron core members include locking iron core members 10 and non-locking iron core members 20. Each locking iron core member 10 includes locking pieces 13 at plural locations of an outer periphery thereof. Each non-locking iron core member 20 does not include the the locking pieces 13. Among plural iron core members fed to the laminated body manufacturing device 1 according to the present exemplary embodiment, at least some of the iron core members are composed as block bodies in which plural numbers of plate-shaped core pieces are bonded to one another. Structures of the locking iron core members 10 and the non-locking iron core members 20 are described below.

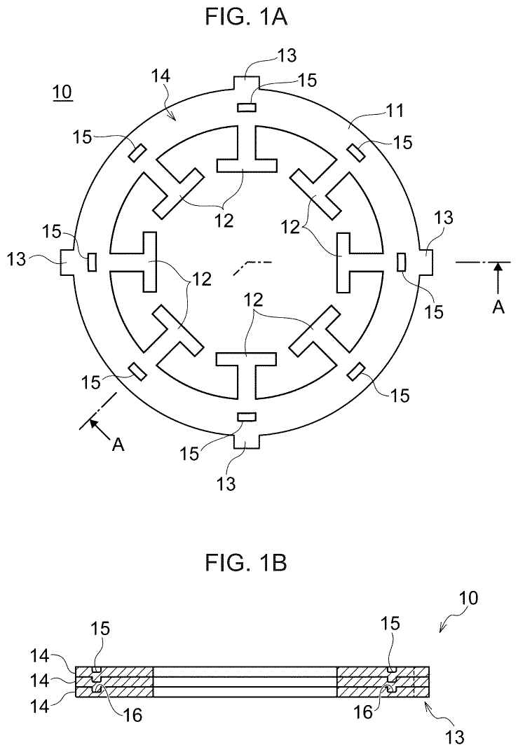

FIG. 1A and FIG. 1B are diagrams showing an example of the locking iron core members fed to the laminated body manufacturing device according to the first exemplary embodiment of the present disclosure. FIG. 1A is a plan view and FIG. 1B is a sectional diagram cut along line A-A in FIG. 1A. As shown in FIG. 1A, each locking iron core member 10 may be formed to include an annular yoke 11, teeth 12 with substantial “T” shapes in plan view, and the locking pieces 13. A penetrating hole that allows disposition of a rotor core is formed in a central portion of the yoke 11. The teeth 12 are provided at the inner periphery of the yoke 11 so as to protrude into the central portion of the yoke 11. The locking pieces 13 are formed as protrusions projecting in outer side directions from the outer periphery of the yoke 11.

As shown in FIG. 1B, the locking iron core member 10 may be composed as a block body in which a plural number (three in FIG. 1B) of plate-shaped core pieces 14 are bonded to one another. The core pieces 14 have relatively small predetermined thicknesses. The core pieces 14 may be formed of electrical steel plate in thin plate shapes. A number of the core pieces 14 composing the block body is not particularly limited but may be suitably adjusted in, for example, a range from a small number to the order of several tens.

Fastening portions 15 may be formed at suitable locations of the yoke 11 of each core piece 14, for bonding the plural core pieces 14 composing a block body to one another. When the core pieces 14 are being laminated with one another, the core pieces 14 may be bonded to one another by the fastening portions 15 engaging with one another. Of the plural core pieces 14 composing the block body, the core piece 14 that is disposed at a bottom portion may be provided with hole portions 16 instead of the fastening portions 15 being formed thereat. The fastening portions 15 of the core piece 14 that is adjacent may be press-inserted into these hole portions 16. Providing the hole portions 16 instead of the fastening portions 15 at the core piece 14 at the bottom portion of the block body prevents unintended bonding to another adjacent iron core member. In the present exemplary embodiment, an example is described in which the fastening portions 15 are employed as a structure for bonding the core pieces 14 to one another. However, an alternative bonding method may be employed, for example, a method of bonding core pieces to one another by applying adhesive to bonding surfaces or the like. When an adhesive is employed, even if conveyance is performed before curing or during curing of the adhesive, strength of the iron core members is raised by surface tension, viscosity and the like, and dropping attitudes may be kept stable. Employing a liquid with high surface tension, viscosity or the like in place of an adhesive may provide similar effects.

The plural core pieces 14 composing the locking iron core member 10 illustrated in FIG. 1B are all provided with projections structuring the locking pieces 13. However, providing the projections at least at, of the plural core pieces 14, the core piece 14 that is disposed at the bottom portion of the locking iron core member 10 is sufficient. That is, a structure may be employed in which the projections structuring the locking pieces 13 are not provided at the core pieces 14 disposed above the bottom portion of the locking iron core member 10 forming the block body. For example, structures similar to core pieces 24 that compose the non-locking iron core members 20 may be employed.

The teeth 12 provided at the inner periphery of each locking iron core member 10 may be provided in a plural number, for example, eight, at substantially equal intervals along the inner periphery. Electromagnetic coils are wound around the teeth 12 during assembly to a stator core. The locking pieces 13 provided at the outer periphery of the locking iron core member 10 may be provided in a plural number, for example, four, at substantially equal intervals along the outer periphery of the locking iron core member 10. Positions at which the four locking pieces 13 are provided are preferably, as illustrated in FIG. 1A, positions at the outer side in the diametric direction of some of the eight teeth 12 provided at the inner periphery of the locking iron core member 10. In general, magnetic flux density generated when the locking iron core member 10 is operated as a portion of a motor core tends to be lower at diametric direction outer sides of the teeth 12 than at other locations. Therefore, when the locking pieces 13 are disposed at the diametric direction outer sides of the teeth 12 as described above, a deterioration in magnetic characteristics of the motor core caused by the provision of the locking pieces 13 may be suppressed.

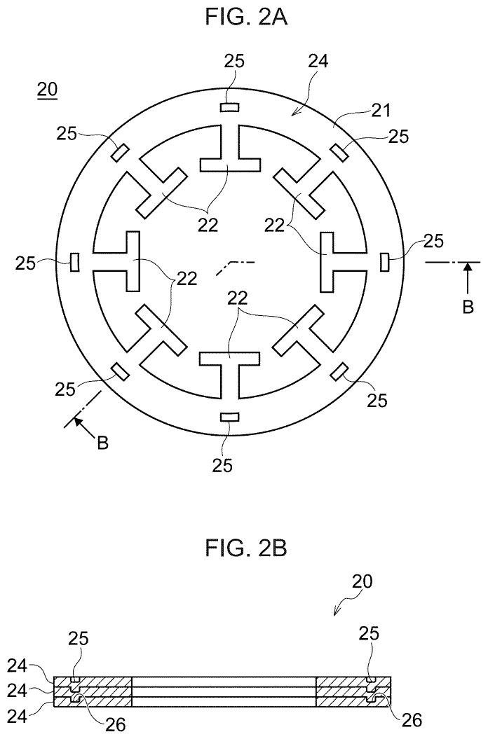

FIG. 2A and FIG. 2B are diagrams showing an example of non-locking iron core members fed to the laminated body manufacturing device according to the first exemplary embodiment of the present disclosure. FIG. 2A is a plan view and FIG. 2B is a sectional diagram cut along line B-B in FIG. 2A. As shown in FIG. 2A, each non-locking iron core member 20 may be formed to include an annular yoke 21 and teeth 22 with substantial “T” shapes in plan view. A penetrating hole that allows disposition of a rotor core is formed in a central portion of the yoke 21. The teeth 22 are provided at the inner periphery of the yoke 21 so as to protrude into the central portion of the yoke 21. Dimensions and numbers of the yokes 21 and teeth 22 of the non-locking iron core members 20 may be specified to fit with dimensions and numbers of the yokes 11 and teeth 12 of the locking iron core members 10.

Similarly to the locking iron core member 10 described above, the non-locking iron core member 20 may be composed as a block body in which a plural number (three in FIG. 2B) of the plate-shaped core pieces 24 are bonded. The core pieces 24 have relatively small predetermined thicknesses. Accordingly, fastening portions 25 and hole portions 26 may be formed in the core pieces 24 for bonding the core pieces 24 to one another. Similarly to the core pieces 14 described above, the core pieces 24 may be formed of electrical steel plate in thin plate shapes. A number of the core pieces 24 composing the non-locking iron core member 20 is not particularly limited but may be suitably altered in, for example, a range from a small number to the order of several tens, irrespective of the number of core pieces 14 in each locking iron core member 10 and the like. The locking iron core members 10 and non-locking iron core members 20 may be formed in modes that are not block bodies, that is, modes composed just of single core pieces 14 and 24.

### Laminated Body Manufacturing Device

FIG. 3 is a schematic descriptive diagram showing an example of the laminated body manufacturing device according to the first exemplary embodiment of the present disclosure. In FIG. 3, the locking iron core members 10 and non-locking iron core members 20 are illustrated in sectional views cut at positions corresponding to the line A-A shown in FIG. 1A. In FIG. 3, to aid understanding of states of the locking pieces 13, dimensions of the locking pieces 13 alone are shown larger than actual dimensions, and the penetrating holes formed at the centers of the iron core members 10 and 20, the fastening portions 15 and 25 and so forth are not shown in the drawing. FIG. 3 shows small gaps formed between the respective iron core members such that boundaries of the iron core members being conveyed in a laminated state can be viewed.

As shown in FIG. 3, the laminated body manufacturing device 1 according to the present exemplary embodiment includes at least a feed mechanism 30, a receiving member 40 and a dividing mechanism 50. The feed mechanism 30 is capable of feeding the locking iron core members 10 and non-locking iron core members 20 described above. The receiving member 40 is capable of receiving plural iron core members fed from the feed mechanism 30. The dividing mechanism 50 is provided between the feed mechanism 30 and the receiving member 40 in a conveyance direction of the iron core members and controls the feeding of the iron core members to the receiving member 40. Below, descriptions are given referring to the direction indicated by arrow X in FIG. 3 as a left-and-right direction and, similarly, the direction indicated by arrow Y as a front-and-rear direction and the direction indicated by arrow Z as a vertical direction.

The feed mechanism 30 may include a press that selectively stamps out the core pieces 14 and 24, which are to compose the locking iron core members 10 and non-locking iron core members 20, from a steel plate strip 2 that is conveyed in the direction of arrow A1 in FIG. 3. This feed mechanism 30 may include a die (also referred to as a lower mold) 31 and a punch (also referred to as an upper mold) 32. The die 31 supports a portion of the steel plate strip 2 that is being conveyed along with a support table 33 that also supports the steel plate strip 2. The punch 32 is disposed above the die 31. The punch 32 may stamp out the core pieces 14 and 24 from the steel plate strip 2 by being actuated in the direction of arrow A2 in FIG. 3.

Each core piece 14 or 24 stamped out by the punch 32 is pressed to below the die 31 and laminated with another of the core pieces 14 or 24 that was stamped immediately prior. When the stamped core piece 14 or 24 and the other core piece 14 or 24 are to compose a single block body and the stamped core piece 14 or 24 is to be laminated onto the other core piece 14 or 24, the two core pieces 14 or 24 are bonded to one another by the fastening portions 15 or 25. Thus, the feed mechanism 30 according to the present exemplary embodiment may be considered to include the function of laminating the core pieces 14 and 24 to compose the locking iron core members 10 and non-locking iron core members 20 that are composed as block bodies.

The receiving member 40 is disposed below the feed mechanism 30 and may be structured with a jig that receives the locking iron core members 10 and non-locking iron core members 20 fed from the feed mechanism 30. The receiving member 40 may include a seat 41, plural support poles 42 and a conveyance arm 43. The locking iron core members 10 and non-locking iron core members 20 fed from the feed mechanism 30 are placed on the seat 41. The support poles 42 extend upward from an upper face of the seat 41 and laterally support the locking iron core members 10 and non-locking iron core members 20. The conveyance arm 43 moves the seat 41 in arbitrary directions. The conveyance arm 43 may support the seat 41 from below and may be capable of moving the seat 41 in predetermined directions, for example, at least one of the front-and-rear direction, the left-and-right direction and the vertical direction. Furthermore, the conveyance arm 43 may function as a rotating mechanism that rotates the seat 41. That is, the conveyance arm 43 may be capable of rotating the supported seat 41 in, for example, the direction indicated by arrow A5 in FIG. 3 about a rotation axis AR that extends in the vertical direction.

The structure of the receiving member 40 described above is an example. The receiving member 40 is not limited to the jig described above, provided the receiving member 40 is capable of receiving the iron core members 10 and 20 fed from the feed mechanism 30. More specifically, the receiving member 40 may be structured by alternative conveying means such as a conveyor belt, a slope or the like.

The dividing mechanism 50 may control the feeding of the locking iron core members 10 and non-locking iron core members 20 being conveyed downward to the receiving member 40. The dividing mechanism 50 includes at least a locking part 51 and an actuator 52. The locking part 51 touches and restricts movement of the locking iron core members 10 being conveyed. The actuator 52 serves as an example of an actuating device that actuates the locking parts 51. The downward direction mentioned above corresponds to the conveyance direction of the iron core members 10 and 20 in the present exemplary embodiment.

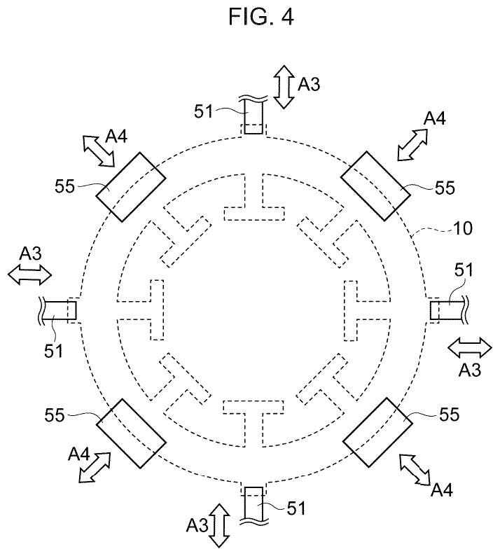

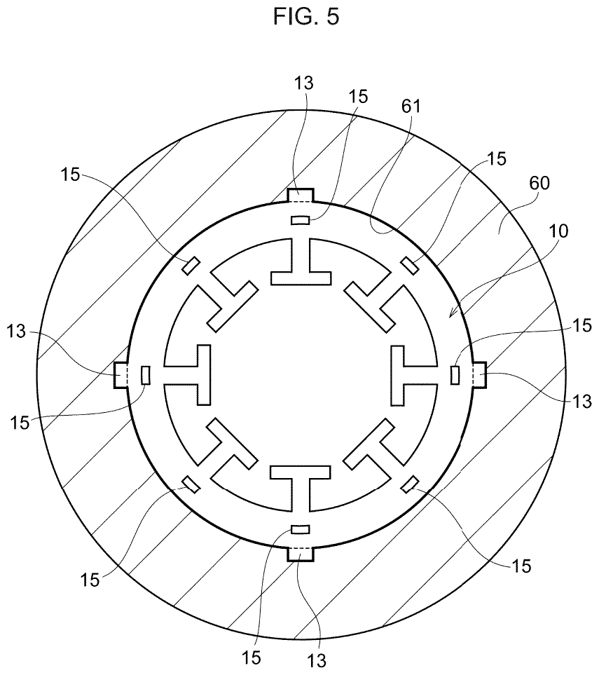

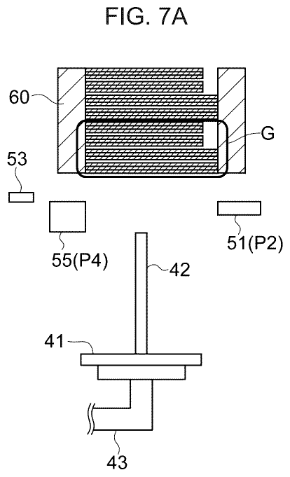

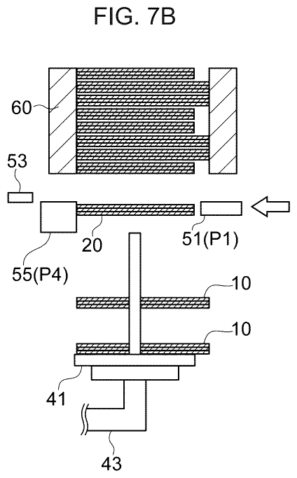

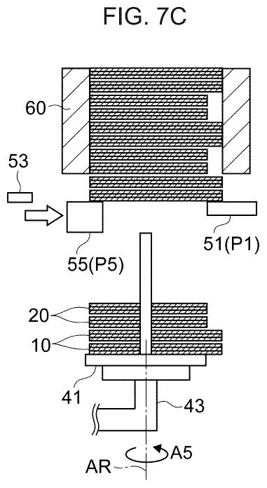

FIG. 4 is a schematic sectional diagram cut along line C-C in FIG. 3. As shown in FIG. 3 and FIG. 4, a plural number of the locking part 51 may be provided encircling the iron core members that are being conveyed. More specifically, four of the locking parts 51 may be provided, matching the number of the locking pieces 13 provided at each locking iron core member 10. The locking parts 51 may be structures that can each be moved between a locking position P1 (see FIG. 7A to FIG. 7C) and a non-locking position P2 (see FIG. 7A to FIG. 7C). The locking parts 51 at the locking positions P1 respectively lock the plural locking pieces 13 of the locking iron core member 10 fed from the feed mechanism 30. The locking parts 51 at the non-locking positions P2 do not lock any of the locking pieces 13. That is, the locking positions P1 may be specified at arbitrary positions on movement paths along which the locking pieces 13 of each locking iron core member 10 being conveyed along the conveyance path move, and the non-locking positions P2 may be specified at positions that do not overlap with the movement paths of the locking pieces 13. FIG. 4 depicts a state in which the locking parts 51 are at the locking positions P1. In FIG. 4, the locking iron core member 10 being conveyed through this location is shown by dotted lines, and members disposed downward relative to the dividing mechanism 50, for example, the receiving member 40 and the like, are not shown in the drawing.

The actuator 52 may operate each locking part 51. More specifically, the locking part 51 may be operated in, for example, the directions indicated by arrow A3 in FIG. 4 so as to move between the locking position P1 and non-locking position P2 mentioned above. A widely known linear movement device, such as an air cylinder, a single-axis robot or the like, may be employed as the actuator 52 according to the present exemplary embodiment. The locking part 51 may be actuated by this actuator 52 so as to move between the locking position P1 that is provided in the direction relatively closer to the locking iron core member 10 and the non-locking position P2 that is provided in the direction relatively further from the locking iron core member 10. Movement directions of the locking parts 51 by the actuators 52 are not limited to those described above and may be suitably altered in accordance with shapes of the locking pieces 13 and the like.

The dividing mechanism 50 according to the present exemplary embodiment may further include a sensor 53 that is capable of detecting when the iron core members pass through an arbitrary location on the conveyance path. A preferable arbitrary location is an arbitrary location between a lower end portion of a squeeze 60 and an upper end portion of the locking parts 51; a position close to the upper end of the locking parts 51 is more preferable. A widely known detection device may be employed for the sensor 53, for example, an infrared sensor, a two-dimensional camera or the like.

Strengths of the locking pieces 13 of each locking iron core member 10 are relatively low when, for example, the number of core pieces 14 composing the locking iron core member 10 is small or the like. When the dividing mechanism 50 is supporting a locking iron core member 10, in addition to the weight of the locking iron core member 10 including the locking pieces 13, the weight of each non-locking iron core member 20 discharged from the squeeze 60 and laminated onto the locking iron core member 10 acts on the locking pieces 13. As a result, the locking pieces 13 may be deformed by this weight, disabling the control of feeding of the iron core members to the receiving member 40. With regard to this, the laminated body manufacturing device 1 according to the present exemplary embodiment preferably further includes retaining mechanisms 55 to assist support of the locking iron core members 10 by the locking pieces 13.

As shown in FIG. 3 and FIG. 4, each retaining mechanism 55 may be provided at a similar height position to the dividing mechanism 50. The retaining mechanism 55 may be operable so as to move between a locking position P3 (not shown in the drawings), at which the retaining mechanism 55 may support at least a portion of a region of the outer circumference of the locking iron core member 10 at which no locking piece 13 is provided, and a non-locking position P4 (not shown in the drawings), at which the retaining mechanism 55 does not support that portion of the outer circumference. To support the iron core member stably, a length (below referred to as width) of the retaining mechanism 55 in a direction along the outer periphery of the locking iron core member 10 may be specified to be larger than the width of each locking part 51. Operation directions of the retaining mechanism 55 may be the directions indicated by arrow A4 in FIG. 4, that is, directions approaching and moving away from the locking iron core member 10. When these retaining mechanisms 55 are included, each locking iron core member 10 being fed to the receiving member 40, or each locking iron core member 10 and each non-locking iron core member 20 laminated on that locking iron core member 10, may be supported by the dividing mechanism 50 and the retaining mechanisms 55. As a result, feeding of the iron core members to the receiving member 40 may be controlled reliably.

FIG. 5 is a schematic sectional diagram cut along line D-D in FIG. 3. The laminated body manufacturing device 1 according to the present exemplary embodiment includes the squeeze 60, in addition to the structures described above, between the feed mechanism 30 and the dividing mechanism 50 in the conveyance direction of the locking iron core members 10 and non-locking iron core members 20. The squeeze 60 conveys the locking iron core members 10 and the non-locking iron core members 20. As illustrated in FIG. 3 and FIG. 5, the squeeze 60 may be structured as a substantially circular tube-shaped member that conveys the locking iron core members 10 and non-locking iron core members 20 that are pushed out to below the die 31 towards the receiving member 40. Accordingly, an upper end portion of the squeeze 60 may be disposed so as to be in communication with a lower end portion of the die 31, in addition to which the upper end portion of the squeeze 60 may be attached to the support table 33.

As shown in FIG. 5, an inner periphery 61 of the squeeze 60 may be adjusted to a size matching shapes of the locking iron core members 10 and non-locking iron core members 20 to be conveyed. Therefore, sides (that is, outer perimeters) of the locking iron core members 10 and non-locking iron core members 20 passing through the interior of the squeeze 60 may abut against and be supported by the inner periphery 61 of the squeeze 60. The inner periphery 61 of the squeeze 60 according to the present exemplary embodiment is formed in a shape that matches the outer perimeter shapes of the locking iron core members 10, but an alternative structure is possible provided that structure is capable of supporting the locking iron core members 10 and non-locking iron core members 20. For example, a shape that abuts only against portions of the outer peripheries of the iron core members is applicable. FIG. 3 and FIG. 7A to FIG. 7C and such, which are described below, illustrate examples in which, for ease of understanding, numbers of the iron core members being conveyed in the squeeze 60 are relatively small, but numbers of iron core members that can be conveyed in the squeeze 60 may be tens or hundreds. The total number of iron core members composing a laminated body may also be tens or hundreds.

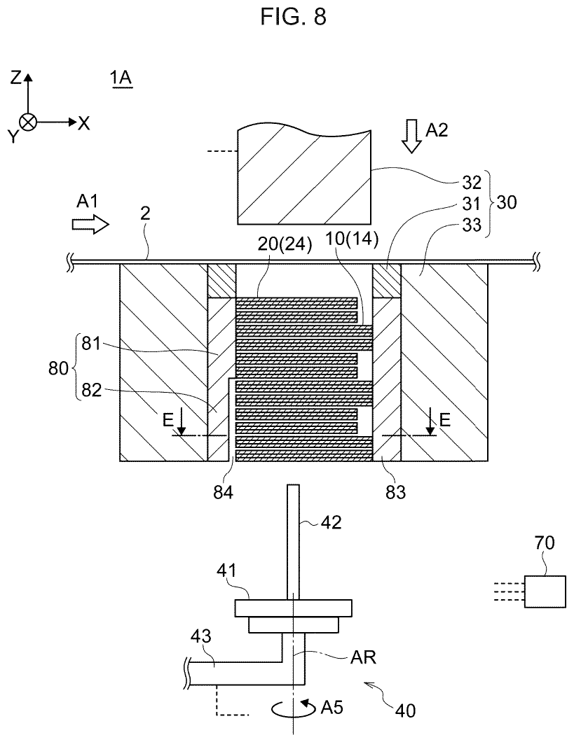

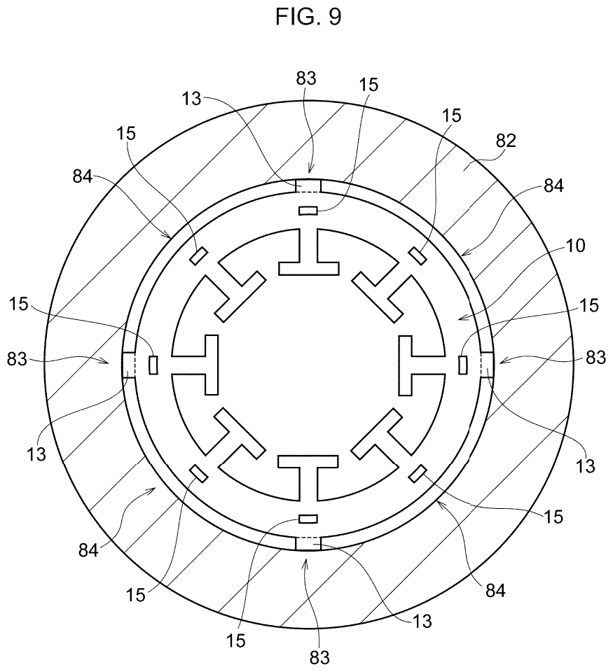

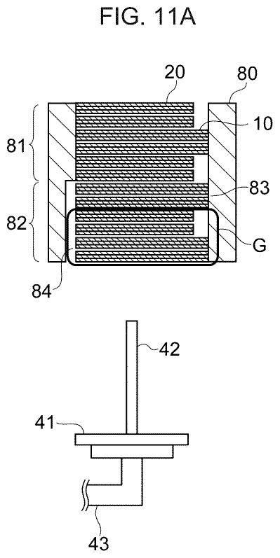

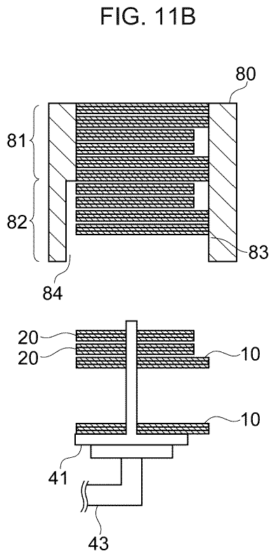

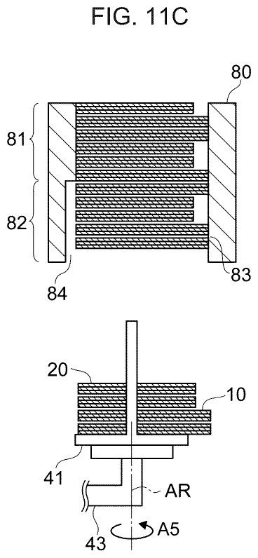

The locking iron core members 10 and non-locking iron core members 20 that are continuously fed from the feed mechanism 30 may be sequentially fed into and supported at the upper end of the squeeze 60. Each time a new locking iron core member 10 or non-locking iron core member 20 is fed into the squeeze 60, the locking iron core members 10 and non-locking iron core members 20 that are already retained in the squeeze 60 are pressed down by the newly conveyed locking iron core member 10 or non-locking iron core member 20. The locking iron core members 10 or non-locking iron core members 20 retained in the squeeze 60 are conveyed downward in the squeeze 60 by an amount corresponding to the thickness of the locking iron core member 10 or non-locking iron core member 20 newly fed into the squeeze 60. In FIG. 3 and in FIG. 7A to FIG. 7C, FIG. 8 and FIG. 11A to FIG. 11C, which are described below, small gaps are shown between the iron core members so as to aid understanding of boundary regions between the iron core members. However, the locking iron core members 10 and non-locking iron core members 20 that are adjacent in the squeeze 60 according to the present exemplary embodiment are conveyed in laminated states, that is, states touching one another. The same applies to the subsequent conveyance of the iron core members onto the receiving member 40 illustrated in FIG. 7A to FIG. 7C and FIG. 11A to FIG. 11C.

The laminated body manufacturing device 1 according to the present exemplary embodiment may further include a control device 70 for controlling the structural elements described above. The control device 70 may, for example, be connected to the structural elements to be capable of communications by wired or wireless communications, as depicted by the dotted lines in FIG. 3. A computer including a sequencer (a programmable logic controller (PLC)) may be employed for the control device 70.

Because the laminated body manufacturing device 1 according to the present exemplary embodiment has the structures described above, particularly the structure in which the locking parts 51 of the dividing mechanism 50 lock the locking pieces 13, the locking parts 51 do not come into contact with the non-locking iron core members 20. Therefore, a period in which the non-locking iron core members 20 are passing through the location of the conveyance path at which the dividing mechanism 50 is provided may be utilized as a duration for moving the locking parts 51 to the locking positions P1. As a result, the laminated body manufacturing device 1 described above may assure a duration for moving the locking parts 51 to the locking positions P1 that is longer than in conventional technologies. Thus, even if components with fast response speeds are not employed for the actuator 52, sensor 53 and the like included at the dividing mechanism 50, lamination of the iron core members may be conducted accurately. Therefore, the lamination of the iron core members may be conducted accurately and efficiently without requiring specialist equipment or the like. In addition, this laminated body manufacturing device 1 may be fabricated at relatively low cost and a frequency of maintenance may be kept down.

The laminated body manufacturing device 1 described above is an example in which the locking pieces 13 are formed as protrusions projecting from the outer circumference of the locking iron core member 10 and the locking parts 51 are operated in directions approaching and moving away from the central portion of the locking iron core member 10, but the present disclosure is not limited thus. For example, instead of the locking pieces 13 being provided at the locking iron core member 10, portions of the outer circumference of the locking iron core member 10 may be utilized as locking pieces and indented portions may be formed at corresponding locations of the non-locking iron core member 20. Further, the operation directions of the locking parts 51 may be directions along the circumferential direction of the iron core members instead of the directions along the radial direction of the iron core members.

The laminated body manufacturing device 1 described above is an example in which the locking pieces are formed as projections protruding from the outer periphery of the locking iron core member 10 and the dividing mechanism 50 is provided at the outer sides of the conveyance path of the iron core members. However, the locking pieces 13 may be formed at the inner periphery of the locking iron core member 10, in which case the dividing mechanism 50 may be disposed at the inner periphery side of the iron core members.

### Laminated Body Manufacturing Method

Now, the laminated body manufacturing method according to the present exemplary embodiment is described. The descriptions below illustrate a situation in which the laminated body manufacturing device 1 described above is used to manufacture laminated bodies. However, the laminated body manufacturing method of the present disclosure may be embodied with devices other than the laminated body manufacturing device 1. A device in which the dividing mechanism 50 of the laminated body manufacturing device 1 is disposed at the inner periphery side of the iron core members can be mentioned as an example of a device other than the laminated body manufacturing device 1. In this device, the locking pieces 13 of the locking iron core member 10 are formed at the inner periphery of the yoke 11. Descriptions of effects and the like presented below are also applicable to descriptions of effects of the laminated body manufacturing device 1 according to the present exemplary embodiment.

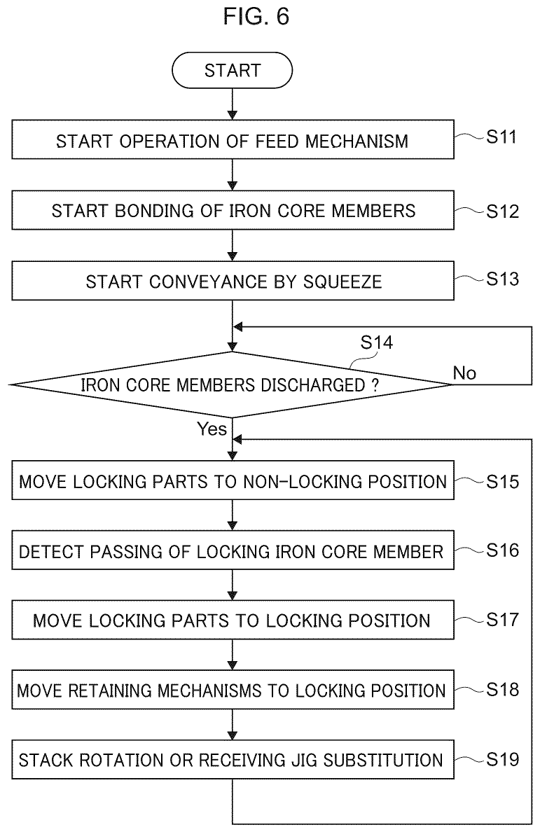

FIG. 6 is a flowchart showing an example of the laminated body manufacturing method according to the first exemplary embodiment of the present disclosure. FIG. 7A to FIG. 7C are operation description diagrams showing states of the manufacturing device when the laminated body manufacturing method illustrated in FIG. 6 is performed. In FIG. 7A to FIG. 7C, to aid understanding of conveyance states of the iron core members being conveyed from the squeeze 60 to the receiving member 40, only locations in the laminated body manufacturing device 1 relating to the conveyance are shown; other portions are not shown in the drawings.

The laminated body manufacturing method described below illustrates a structure in which, for example, as illustrated in FIG. 1, the locking iron core members 10 and non-locking iron core members 20 composing the laminated bodies are formed as block bodies in which sets of three of the core pieces 14 and 24 are bonded. The present manufacturing method illustrates a method in which stack rotation is conducted each time a predetermined number of iron core members have been laminated at the receiving member 40. The meaning of the term “stack rotation” as used herein is intended to include rotating the orientation of the electrical steel plate and laminating the same while laminating the iron core members. Because this stack rotation is conducted, retention of a magnetic orientation in the stator core containing these laminated bodies may be suppressed. In addition, a reduction in perpendicularity or parallelism of the stator core due to variations in plate thickness of the iron core members may be suppressed.

This stack rotation may be conducted by rotating the receiving member 40 retaining a predetermined number of the iron core members by a predetermined angle (in, for example, the direction of arrow A5) about the rotation axis AR along the conveyance direction. The present exemplary embodiment illustrates stack rotation in which the conveyance arm 43 is used to rotate the receiving member 40 by a predetermined angle (for example, 90°or 180°) each time four of the iron core members 10 and 20 are placed on the seat 41. Below, the four iron core members that are laminated between stack rotations/a substitution of the receiving member 40 are collectively referred to as an iron core group G (see FIG. 7A). These iron core groups G structure the block cores mentioned above. To aid understanding, the present exemplary embodiment illustrates a situation in which the total number of iron core members composing a laminated body is relatively small, and the timing at which stack rotation is performed is each time four of the iron core members have been placed. However, when more iron core members compose the laminated bodies than in this situation and so forth, the stack rotation may be conducted, for example, each time several tens of the iron core members have been placed.

The laminated body manufacturing method according to the present exemplary embodiment includes at least: a step of bonding a plural number of the plate-shaped core pieces 14 and 24 to one another to form a block body (see step S12 described below); a step of feeding plural iron core members from the feed mechanism 30 (see step S11 described below); a step of using the squeeze to laterally support the iron core members fed from the feed mechanism (see step $13 described below); a step of using the dividing mechanism 50 to selectively support the iron core members fed from the feed mechanism 30 (see step S17 and the like described below); a step of moving the locking parts 51 of the dividing mechanism 50 from the locking position P1 to the non-locking position P2 for feeding plural iron core members supported by the dividing mechanism 50 to the receiving member 40 (see step S15 described below); and a step of returning the locking parts 51 that have moved to the non-locking position P2 to the locking position P1 in a period in which the non-locking iron core members 20 are passing through a location on the conveyance path of the iron core members that encompasses the locking position P1 (see step $17 described below).

To describe the laminated body manufacturing method according to the present exemplary embodiment in more detail, the manufacturing method first starts stamping operation of the core pieces 14 and 24 by the feed mechanism 30 (step S11). This stamping operation may be executed by lowering the punch 32 to the steel plate strip 2 that is being fed in one direction, for example, the left-and-right direction, at predetermined timings. The core pieces 14 and 24 that are stamped out are pressed by the punch 32 and moved to below the die 31, and are pushed into the squeeze 60 through the upper end portion of the squeeze 60 that is in communication with the die 31.

In the present exemplary embodiment, stack rotation or a substitution of the receiving member 40 is carried out each time an iron core member group G formed of four iron core members as mentioned above is laminated. Correspondingly, of the plural number (four in FIG. 8) of iron core members composing one iron core member group G, which are iron core members composed of the core pieces 14 and 24 that are stamped out in the above-described step S11, one or a plural number of the iron core members disposed at the downstream side may be the locking iron core members 10, and one or a plural number of the iron core members disposed at the upstream side may be the non-locking iron core members 20. That is, of the plural iron core members composing one iron core member group G, at least the iron core member formed of the core pieces 14 that are stamped out first is the locking iron core member 10, and others of the core members may be the non-locking iron core members 20. This is because the iron core member disposed furthest to the downstream side of an iron core member group G must be supported in order for feeding of the iron core members to the receiving member 40 to be temporarily paused by the dividing mechanism 50 when a stack rotation or a substitution of the receiving member 40 is to be carried out.

The fastening portions 15 and 25 and hole portions 16 and 26 are formed in advance at the core pieces 14 and 24 that are stamped out by the die 31 and punch 32, for the bonding of adjacent core pieces 14 and 24 in the squeeze 60. When the core pieces 14 and 24 at which the fastening portions 15 and 25 are formed are pushed into the squeeze 60 in step S11, the fastening portions 15 or 25 that are formed at each core piece 14 or 24 that is pushed in are press-inserted into the fastening portions 15 or 25 or hole portions 16 or 26 of the core piece 14 or 24 that was pushed in immediately prior. Thus, selective bonding of the laminated core pieces 14 and 24 to one another is started (step S12).

At the core piece 14 or 24 that composes the bottom portion of one of the locking iron core members 10 or one of the non-locking iron core members 20, the hole portions 16 or 26 are formed in advance instead of the fastening portions 15 or 25. As a result, when a core piece 14 or 24 stamped out by the die 31 and punch 32 is the core piece 14 or 24 that composes the bottom portion of the locking iron core member 10 or non-locking iron core member 20, this core piece 14 or 24 is not bonded to the core piece 14 or 24 that was pushed into the squeeze 60 immediately prior. Thus, the locking iron core members 10 and non-locking iron core members 20 are conveyed in the squeeze 60 without being bonded.

At least portions of the outer peripheries of the core pieces 14 and 24 that are pushed into the squeeze 60 and bonded to one another, which is to say portions of the outer peripheries of the locking iron core members 10 and non-locking iron core members 20, are laterally supported by the inner periphery 61 of the squeeze 60. The locking iron core members 10 and non-locking iron core members 20 that are laterally supported are conveyed downward in the squeeze 60 (step S13). The conveyance of the iron core members by the squeeze 60 may be implemented by new core pieces being fed in from the feed mechanism 30 to the upper end portion of the squeeze 60, and other iron core members fed from the feed mechanism 30 previously and retained in the squeeze 60 being pushed down by the new core pieces. Thus, the iron core members retained in the squeeze 60 are conveyed along the conveyance direction while laminated states thereof are maintained.

The operations described above in step S11 to step S13 are started substantially simultaneously in conjunction with operation of the punch 32 starting. Alternatively, of step S11 to step S13, step S12 may be performed in advance. More specifically, for example, plural numbers of the core pieces 14 or 24 may be bonded in advance to make the locking iron core members 10 and non-locking iron core members 20, and these locking iron core members 10 and non-locking iron core members 20 may be pushed into the upper end portion of the squeeze 60 sequentially. In this alternative, employing a press equipped with a ram for the feed mechanism is appropriate for pushing the locking iron core members 10 and non-locking iron core members 20 into the upper end portion of the squeeze 60.

The present exemplary embodiment illustrates the core pieces 14 composing the locking iron core members 10 and the core pieces 24 composing the non-locking iron core members 20 being stamped out alternatingly in sets of six, and the locking iron core members 10 and non-locking iron core members 20 being alternated in sets of two and conveyed in the squeeze 60. Correspondingly, one iron core member group G is formed by two of the locking iron core members 10 and two of the non-locking iron core members 20 being laminated in this order from the downstream side.

When the conveyance of the iron core members by the squeeze 60 has started and a certain duration has passed, the iron core members are sequentially discharged towards the receiving member 40 from the lower end portion of the squeeze 60. When this discharging of the iron core members starts (“Yes” in step S14), as shown in FIG. 7A, each actuator 52 of the dividing mechanism 50 is operated and moves the locking part 51 toward the non-locking position P2 (step S15). The present exemplary embodiment illustrates a situation in which each locking part 51 is at the locking position P1 in an initial state of the laminated body manufacturing device 1. If the locking part 51 is at the non-locking position P2 in the initial state, skipping step S15 is acceptable.

When the locking parts 51 are at the non-locking position P2, the locking parts 51 are not located on the conveyance path of the iron core members. Therefore, the iron core members composing one iron core member group G discharged from the squeeze 60 at this time sequentially move in the downstream direction and are laminated on the seat 41 of the receiving member 40. This movement of the iron core members may be monitored by the sensor 53. The sensor 53 may be arranged to face a location in the vertical direction that encompasses the locking position P1 at which the locking parts 51 of the dividing mechanism 50 lock the locking pieces 13 of the locking iron core member 10 (below, this location is referred to as the “iron core member support position”). Accordingly, the sensor 53 may detect when each locking iron core member 10 is passing through the iron core member support position.

When passage of the locking iron core members 10 of an iron core member group G is detected by the above-mentioned sensor 53 or the like (step S16), as shown in FIG. 7B, the actuators 52 of the dividing mechanism 50 are operated and the movement of the locking parts 51 towards the locking position P1 starts (step S17). The passage of the locking iron core members 10 through the iron core member support position as referred to herein is intended to include the locking iron core member 10 that is disposed furthest to the upstream side in the iron core member group G (in FIG. 7B, the second locking iron core member from the bottom) passing through the iron core member support position.

A method of detecting passage of the locking iron core members 10 through the iron core member support position is not limited to the method described above. For example, the iron core members sequentially passing through the iron core member support position may be detected indirectly on the basis of timings of passage of the locking iron core members 10 through the iron core member support position, which are determined by detecting changes from the locking iron core members 10 to the non-locking iron core members 20 or by, without using a sensor, calculations that take into account feeding numbers of the iron core members from the feed mechanism 30, feeding durations and the like. These surrogate detection methods have lower detection accuracy than the above-described direct detection of passage of the locking iron core members 10 by the sensor 53. However, in the laminated body manufacturing method according to the present exemplary embodiment, a long duration for moving the dividing mechanism 50 from the non-locking position P2 to the locking position P1 may be assured, as described below. Therefore, the above-mentioned surrogate detection methods may be employed.

It is sufficient that the movement of the locking parts 51 to the locking position P1 in step S17 is completed in an interval from when the locking iron core member 10 disposed furthest to the upstream side of one iron core member group G passes through the iron core member support position until the locking iron core member 10 disposed furthest to the downstream side of another iron core member group G that is conveyed next after the one iron core member group G reaches the iron core member support position. As illustrated in FIG. 7B, this period includes a period in which two of the non-locking iron core members 20 pass through the iron core member support position. However, the non-locking iron core members 20 do not have the locking pieces 13 and the locking positions P1 of the locking parts 51 are specified to be in movement paths of the locking pieces 13. Therefore, even if the locking parts 51 are at the locking positions P1 at a timing when the non-locking iron core members 20 are passing through the iron core member support position, the locking parts 51 will not block the conveyance of the non-locking iron core members 20.

In step S17 described above, the actuators 52 are operated at a timing when the locking iron core member 10 that is disposed furthest to the upstream side in the one iron core member group G passes through the iron core member support position. However, depending on the shape of the locking iron core members 10, the operation timing may be even earlier. More specifically, when, as described above, the projections structuring the locking pieces 13 are not formed at, of the core pieces 14 composing the locking iron core member 10, the core pieces 14 that are provided upward relative to the bottom portion of the locking iron core member 10, the actuators 52 may be operated at a timing at which the locking pieces 13 of the locking iron core member 10 disposed furthest to the upstream side in the one iron core member group G pass through the iron core member support position. In this configuration, the actuators 52 may be operated while the locking iron core member 10 is passing through the iron core member support position. Thus, the timing at which the movement of the locking parts 51 toward the locking position P1 starts may be made earlier.

When the movement of the locking parts 51 to the locking position P1 is complete, movement of the retaining mechanisms 55 towards the locking position P3 starts (step S18). The timing of the movement of the retaining mechanisms 55 toward the locking position P3 may be specified to be immediately after the locking iron core member 10 is locked by the locking parts 51 or after a plural number of the locking iron core members 10 (or, depending on the situation, plural locking iron core members 10 and non-locking iron core members 20) are supported at the locking parts 51.

When the movement of the locking parts 51 to the locking position P1 is complete, the iron core members being discharged from the lower end portion of the squeeze 60 are supported by the dividing mechanism 50 and conveyance is temporarily blocked. In this period, the conveyance arm 43 may be operated and rotate the seat 41 on which one iron core member group G has been placed by a predetermined angle (for example, 90°) about the rotation axis AR to conduct stack rotation (step S19). It is sufficient that the timing of execution of a stack rotation is in a period in which the iron core members are supported by the dividing mechanism 50. Therefore, the stack rotation may be executed, for example, before the start of the above-mentioned movement of the retaining mechanisms 55 to the locking position P3 or at the same time as the start of this movement. In step S19, when the number of iron core members placed on the seat 41 has reached a required number, a substitution of the receiving member 40 may be performed instead of the stack rotation.

When the stack rotation operation or substitution of the receiving member 40 in step S19 is complete, the method returns to step S15 and resumes conveyance of the next iron core member group G. More specifically, iron core members whose conveyance has been temporarily blocked by step S17 and that are supported at the dividing mechanism 50 are conveyed to the receiving member 40 (step S15) as a result of the locking parts 51 being moved from the locking position P1 to the non-locking position P2. The retaining mechanisms 55 may be moved to the non-locking position P4 together with the movement of the locking parts 51 to the non-locking position P2.

As described above, according to the laminated body manufacturing method according to the present exemplary embodiment, feeding of the iron core members is controlled by the locking parts 51 of the dividing mechanism 50 coming into contact with the locking pieces 13 of the locking iron core members 10, and a period for moving the locking parts 51 of the dividing mechanism 50 that is longer than in conventional technologies may be assured. Therefore, there is no need to use components with fast response speeds as structural components of the dividing mechanism 50 and the like. In addition, the locking parts 51 may be reliably moved to the locking position P1 and locking of the locking parts 51 with the locking pieces 13 may be implemented stably.

The exemplary embodiment described above illustrates one iron core member group G having two of the locking iron core members 10 at the downstream side and two of the non-locking iron core members 20 at the upstream side. However, an iron core member group G may have only one of the locking iron core members 10 at the downstream side and three of the non-locking iron core members 20 making up the rest of the iron core member group G. When the number of non-locking iron core members 20 composing the iron core member group G is greater, a longer period for movement of the dividing mechanism 50 may be assured.

In particular, the locking iron core members 10 and non-locking iron core members 20 according to the present exemplary embodiment are all structured as block bodies in which plural numbers (specifically, threes) of the core pieces 14 and 24 are bonded. Therefore, the locking iron core members 10 and non-locking iron core members 20 may be formed to be thicker than structures that are formed of a single core piece 14 or 24. Thus, even if one iron core member group G has only one of the locking iron core members 10 as an iron core member at the downstream side, the locking pieces 13 are unlikely to deform due to the weight of the iron core members. When the number of iron core members composing one iron core member group G is large (for example, around a hundred), the locking iron core members 10 are relatively thin or the like, the number of locking iron core members 10 is increased, and the locking pieces 13 of the plural locking iron core members 10 overlap in the conveyance direction. Thus, deformation of the locking pieces 13 may be suppressed.

The present exemplary embodiment illustrates a structure in which the locking iron core members 10 and non-locking iron core members 20 conveyed in the squeeze 60 are all block bodies in which three of the core pieces 14 or 24 are bonded, but the present disclosure is not limited thus. For example, numbers of core pieces composing the iron core members may differ between the respective iron core members.

When the locking iron core members 10 and non-locking iron core members 20 are structured as block bodies in which plural numbers of the core pieces 14 or 24 are bonded, iron loss occurring at the fastening portions 15 or 25 when a motor core is formed is suppressed. Accordingly, greater numbers of the locking iron core members 10 and non-locking iron core members 20 composing one laminated body may be specified. Continuous lengths in the axial direction of the fastening portions 15 and 25 formed in the iron core members may be kept short in proportion to the numbers of the locking iron core members 10 and non-locking iron core members 20 composing one laminated body. Therefore, iron loss when a motor core is formed may be suppressed compared to a structure in which the fastening portions 15 and 25 extend over, for example, the whole axial direction length of the laminated body.

Strengths of the locking iron core members 10 and non-locking iron core members 20 may be raised by forming the locking iron core members 10 and non-locking iron core members 20 as the block bodies in which plural numbers of the core pieces 14 and 24 are bonded. As a result, dropping attitudes when the locking iron core members 10 and non-locking iron core members 20 drop to the seat 41 from the lower end portion of the squeeze 60 are stable. Moreover, deformation of the locking iron core members 10 and non-locking iron core members 20 when inserted into the support poles 42 and insertion failures may be suppressed.

The exemplary embodiment described above illustrates a method that includes the step of moving the retaining mechanisms 55 to the locking position (step S18). However, instead of this step, a step that improves support strength of the iron core members by the locking parts 51 may be employed. More specifically, a step may be employed in which the locking parts 51 are moved to positions (corresponding to retaining positions) that lock, in addition to the locking pieces 13, at least portions of the outer circumference of the locking iron core member 10. When each locking part 51 is operated in the directions indicated by arrow A3 in FIG. 4, if the retaining position is a position to which the locking part 51 is moved further in the direction approaching the central portion of the locking iron core member 10, the support strength of the iron core members by the locking parts 51 may be improved and stable support of the iron core members may be achieved without use of the retaining mechanisms 55 described above.

The laminated body manufactured by the series of steps described above is subjected to welding of the iron core members, winding of coils into slots and the like. The locking pieces 13 may also be used as welding areas when the iron core members are being welded. That is, the laminated body manufacturing method according to the present exemplary embodiment structures the locking pieces 13 as protrusions projecting from the outer peripheries of the locking iron core members 10, and may further include a step of welding the iron core members, using the locking pieces 13 that are structured as protrusions as welding protrusions. When the locking pieces 13 are utilized as welding areas, providing locking pieces and welding protrusions separately is unnecessary.

### Second Exemplary Embodiment

The first exemplary embodiment described above illustrates use of the dividing mechanism 50 to control feeding of the iron core members to the receiving member 40, but the present disclosure is not limited to this structure. Accordingly, as a second exemplary embodiment of the present disclosure, a laminated body manufacturing device and laminated body manufacturing method that do not use the dividing mechanism 50 are described below.

### Laminated Body Manufacturing Device

A manufacturing device 1A according to the present exemplary embodiment may include the same structures as the laminated body manufacturing device 1 according to the first exemplary embodiment, except that members of the dividing mechanism 50 and the like are not included and the structure of the squeeze is different. Accordingly, portions formed with structures similar to the laminated body manufacturing device 1 according to the first exemplary embodiment are assigned the same reference numerals as those used in the descriptions of the first exemplary embodiment and are not described. The descriptions given below are concentrated on structures that differ from the laminated body manufacturing device 1 according to the first exemplary embodiment.

FIG. 8 is a schematic descriptive diagram showing an example of the laminated body manufacturing device according to the second exemplary exemplary embodiment of the present disclosure. FIG. 8 is drawn so as to correspond with FIG. 3. As shown in FIG. 8, the laminated body manufacturing device 1A according to the present exemplary embodiment includes a second squeeze 80, the feed mechanism 30, and the receiving member 40. The second squeeze 80 is capable of conveying, for example, the locking iron core members 10 and non-locking iron core members 20 illustrated in FIG. 1 and FIG. 2 downward. The feed mechanism 30 is disposed above the second squeeze 80 and is capable of selectively feeding the iron core members to the second squeeze 80. The receiving member 40 may be disposed below the second squeeze 80 and is capable of receiving plural iron core members discharged from the second squeeze 80. Similarly to the laminated body manufacturing device 1 according to the first exemplary embodiment, shapes of the iron core members that are laminated by the laminated body manufacturing device 1A according to the present exemplary embodiment are not limited to those illustrated in FIG. 1 and FIG. 2.

The second squeeze 80 may be structured as a substantially circular tube-shaped member that conveys the locking iron core members 10 and non-locking iron core members 20 composed of the core pieces 14 and 24, which are stamped out by the feed mechanism 30 including the die 31 and punch 32 and pushed out to below the die 31, to the receiving member 40. The second squeeze 80 may include a squeeze upstream portion 81 and a squeeze downstream portion 82. The squeeze upstream portion 81 is disposed at the upstream side in the conveyance direction of the iron core members and laterally supports both the locking iron core members 10 and non-locking iron core members 20 passing through the interior of the second squeeze 80. The squeeze downstream portion 82 is disposed at the downstream side in the conveyance direction of the iron core members and laterally supports the locking pieces 13 of the locking iron core members 10 passing through the interior of the second squeeze 80.

The squeeze upstream portion 81 may have a similar structure to the squeeze 60 according to the first exemplary embodiment. That is, the inner periphery of the squeeze upstream portion 81 may have the same shape as the inner periphery 61 of the squeeze 60 shown in FIG. 5.

FIG. 9 is a schematic sectional diagram cut along line E-E in FIG. 8. As shown in FIG. 9, the squeeze downstream portion 82 may be provided with first locking parts 83 at positions of the inner periphery of the squeeze downstream portion 82 that correspond with the locking pieces 13 of the locking iron core members 10. The locking parts 83 laterally abut against the locking pieces 13 and support the locking iron core members 10. The fact that no regions of the squeeze downstream portion 82 apart from the regions where the locking parts 83 are formed support the locking iron core members 10 and non-locking iron core members 20 is a particularly noteworthy feature. In the laminated body manufacturing device 1A according to the present exemplary embodiment, gaps 84 are formed between the inner periphery of the squeeze downstream portion 82 and the outer periphery of each iron core member, except in the regions where the locking parts 83 are formed. It is sufficient that the shape of the inner periphery of the squeeze downstream portion 82 is appropriately modified to suit the shapes of the locking iron core members 10 and non-locking iron core members 20 that are to be conveyed.

Because the laminated body manufacturing device 1A according to the present exemplary embodiment includes the second squeeze 80 described above, only the locking iron core members 10 are conveyed in a supported state in the squeeze downstream portion 82. The non-locking iron core members 20 are not laterally supported by the second squeeze 80 but are moved along the conveyance path in a state of being placed on and supported by upper faces of the locking iron core members 10 disposed at the downstream side. The non-locking iron core members 20 discharged from the lower end portion of the second squeeze 80 are discharged simultaneously with discharge of the locking iron core members 10 disposed at the downstream side of those non-locking iron core members 20.

Given the structure as described above in which the non-locking iron core members 20 and locking iron core members 10 are discharged simultaneously, a time interval from a non-locking iron core member 20 being discharged until the succeeding locking iron core member 10 is discharged from the lower end portion of the second squeeze 80 is long.

Therefore, stack rotation, substitution of the receiving member 40 or the like may be carried out at this time, and lamination of the iron core members may be continuously conducted accurately without the use of specialist equipment or the like for pausing the device for stack rotation, substitution of the receiving member 40 or the like or for controlling feeding timings of the iron core members.

### Laminated Body Manufacturing Method

Now, the laminated body manufacturing method according to the present exemplary embodiment is described. The descriptions below illustrate use of the laminated body manufacturing device 1A described above to manufacture laminated bodies. However, the laminated body manufacturing method of the present disclosure may be embodied with equipment other than the laminated body manufacturing device 1A. Descriptions of effects and the like presented below also apply to descriptions of effects of the laminated body manufacturing device 1A according to the present exemplary embodiment.

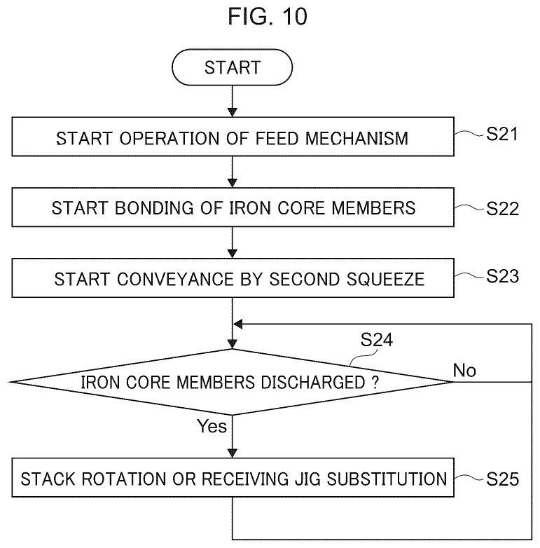

FIG. 10 is a flowchart showing an example of the laminated body manufacturing method according to the second exemplary exemplary embodiment of the present disclosure. FIG. 11A to FIG. 11C are operation description diagrams showing states of principal parts of the laminated body manufacturing device 1A when the laminated body manufacturing method illustrated in FIG. 10 is performed. In FIG. 11A to FIG. 11C, to aid understanding of conveyance states of the iron core members being conveyed from the second squeeze 80 to the receiving member 40, only portions of the laminated body manufacturing device 1A relating to this conveyance are shown; other portions are omitted from the drawings. The laminated body manufacturing method described below illustrates stack rotation being conducted each time a predetermined number of iron core members have been laminated, similarly to the laminated body manufacturing method according to the first exemplary embodiment.

The laminated body manufacturing method according to the present exemplary embodiment includes at least: a step of bonding a plural number of the plate-shaped core pieces 14 and 15 to one another to form a block body (see step S22 described below); a step of feeding plural iron core members to the second squeeze 80 (see step S21 described below); and a step of receiving, at the receiving member 40, each locking iron core member 10 that has passed through the squeeze downstream portion 82 or each locking iron core member 10 that has passed through the squeeze downstream portion 82 with one or a plural number of the non-locking iron core members 20 supported at an upper face of the locking iron core member 10 (see step S23 described below).

To describe the laminated body manufacturing method according to the present exemplary embodiment in more detail, the manufacturing method first starts stamping operation of the core pieces 14 and 24 by the feed mechanism 30 (step S21). The core pieces 14 and 24 that are stamped out are pressed by the punch 32 and moved to below the die 31, and are pushed into the second squeeze 80 through the upper end portion of the second squeeze 80 that is in communication with the die 31.

In the present exemplary embodiment, similarly to the first exemplary embodiment, stack rotation is carried out each time an iron core member group G formed of four iron core members is laminated on the seat 41. Thus, the above-described step S21 illustrates six each of the core pieces 14 composing the locking iron core members 10 and the core pieces 24 composing the non-locking iron core members 20 being stamped out alternatingly, and the locking iron core members 10 and non-locking iron core members 20 being alternated in sets of two and conveyed in the squeeze 60. Correspondingly, one iron core member group G being conveyed in the second squeeze 80 is formed by two of the locking iron core members 10 and two of the non-locking iron core members 20 being laminated in this order from the downstream side.

The fastening portions 15 and 25 and hole portions 16 and 26 are formed in advance at the core pieces 14 and 24 that are stamped out by the die 31 and punch 32, for the bonding of the adjacent core pieces 14 and 24 in the second squeeze 80. When the core pieces 14 and 24 at which the fastening portions 15 and 25 are formed are pushed into the second squeeze 80 as described above, the fastening portions 15 or 25 that are formed at each core piece 14 or 24 that is pushed in are press-inserted into the fastening portions 15 or 25 or hole portions 16 or 26 of the core piece 14 or 24 that was pushed in immediately prior. Thus, the core pieces 14 and 24 are bonded to one another (step S22).

When the stamping operation of the core pieces 14 and 24 by the feed mechanism 30 has started and the core pieces 14 and 24 are pushed into the second squeeze 80, at least portions of the outer peripheries of the locking iron core members 10 and non-locking iron core members 20 composed of the core pieces 14 and 24 are laterally supported by the inner periphery of the squeeze upstream portion 81. Hence, conveyance of the iron core members by the second squeeze 80 is started (step S23). The conveyance of the iron core members by the second squeeze 80 conveys both the locking iron core members 10 and the non-locking iron core members 20 in the conveyance direction in the squeeze upstream portion 81 while maintaining states in which the locking iron core members 10 and non-locking iron core members 20 are laterally supported and laminated.

When the conveyance of the iron core members in the second squeeze 80 progresses and some of the iron core members reach the squeeze downstream portion 82, of these iron core members, lateral support of the locking iron core members 10 is maintained by the locking pieces 13 being in contact with the locking parts 83. Meanwhile, lateral support of the non-locking iron core members 20 is removed and the non-locking iron core members 20 are supported by the upper faces of the locking iron core members 10 disposed at the downstream side (see FIG. 11A).

When the conveyance of the iron core members by the second squeeze 80 progresses further, of the iron core members composing one iron core member group G, first the locking iron core member 10 that is disposed furthest to the downstream side is discharged from the lower end portion of the second squeeze 80. Next, the locking iron core member 10 that is conveyed in a state in which the lower face thereof is abutted against and laminated to the upper face of the locking iron core member 10 that is disposed furthest to the downstream side is discharged from the lower end portion of the second squeeze 80 (below, to aid understanding of the descriptions, this locking iron core member 10 is referred to for expedience as “the second locking iron core member 10”).

The two non-locking iron core members 20 included in the same iron core member group G are placed on and supported by the upper face of the second locking iron core member 10. Because the non-locking iron core members 20 are not laterally supported in the squeeze downstream portion 82, when the second locking iron core member 10 is discharged from the lower end portion of the second squeeze 80, the two non-locking iron core members 20 are also discharged from the lower end portion of the second squeeze 80 at the same time, as shown in FIG. 11B. At this time, the laminated locking iron core members 10 upstream of the two non-locking iron core members 20 discharged from the lower end portion of the second squeeze 80 are being conveyed through a location distant from the lower end portion of the second squeeze 80.

When the second locking iron core member 10 and the two non-locking iron core members 20 supported at the upper face thereof are placed on the seat 41 of the receiving member 40 (“Yes” in step S24), as illustrated in FIG. 11C, the conveyance arm 43 is operated and the seat 41 on which the one iron core member group G is placed is rotated by a predetermined angle (for example, 90°) about the rotation axis AR to conduct stack rotation (step S25). At the time when the stack rotation is conducted, as mentioned above, the next locking iron core members 10 to be conveyed to the receiving member 40 are being conveyed through a location distant from the lower end portion of the second squeeze 80. Therefore, a relatively long duration is assured before the locking iron core members 10 being conveyed in the second squeeze 80 are discharged from the lower end portion of the second squeeze 80. Thus, there is no discharging from the second squeeze 80 while the stack rotation is being conducted. When the number of iron core members placed on the seat 41 has reached a required number, a substitution of the receiving member 40 may be performed instead of a stack rotation in step S25. When the stack rotation operation or substitution of the receiving member 40 in step S25 is complete, the method may return to step S24 and wait for conveyance of the succeeding iron core member group G.

According to the laminated body manufacturing method according to the present exemplary embodiment as described above, timings of discharge of the iron core members discharged from the lower end portion of the second squeeze 80 may be adjusted by modifying portions of the inner periphery of the second squeeze 80. Thus, laminated bodies may be continuously fabricated by a simple structure. Furthermore, because the squeeze downstream portion 82 has the structure that supports only the locking iron core members 10, each time an iron core member group G is discharged, a long duration may be assured before the succeeding discharge. Therefore, stack rotations, substitutions of the receiving member 40 and the like may be conducted reliably.

In the laminated body manufacturing device 1A and laminated body manufacturing method according to the present exemplary embodiment, of the plural core pieces 14 composing each locking iron core member 10, the protrusions structuring the locking pieces 13 may be provided only at the core pieces 14 that are disposed at the bottom portion of the locking iron core member 10. With this structure, side pressure on the locking iron core member 10 from the second squeeze 80 is released at the same time as the core pieces 14 at which the protrusions are provided are discharged from the second squeeze 80. When the number of core pieces 14 composing each locking iron core member 10 is large, a proportion of core pieces without the protrusions among the core pieces 14 composing the locking iron core member 10 may be increased. This is because, in an iron core member 10, when some core pieces 14 with protrusions have been released from the side pressure while other core pieces 14 with protrusions have not, it can suppress the separation between the core pieces 14 caused by the weight of the core pieces 14 from which the side pressure has been released. Thus, increasing the proportion of the core pieces 14 at which the protrusions are not provided may suppress detachment between the core pieces 14. Hence, fastening strengths in order to suppress detachment may be reduced. That is, numbers of fastenings in the iron core members may be reduced, enabling a reduction in iron loss.

The present disclosure is not limited by the exemplary embodiments described above and numerous modifications may be embodied within a scope not departing from the gist of the present disclosure. All these modifications are to be encompassed by the technical idea of the present disclosure.

All references cited in this specification, including publications, patent applications, and patents, are herein incorporated by reference to the same extent as if each reference was individually and specifically indicated to be incorporated by reference and the contents of each reference were fully set forth herein.

The use of nouns and similar designations in connection with the descriptions of this disclosure (particularly in connection with the claims below) shall be construed to cover both the singular and the plural, unless otherwise indicated herein or clearly contradicted by context. The terms “comprises”, “has”, “includes” and “contains” shall be construed as open-ended terms (meaning “including but not limited to”), unless otherwise indicated. The recitation of numerical ranges herein is intended merely to serve as a shorthand method for individually referring to each value falling within the range, unless otherwise indicated herein, and each value is incorporated into the specification as if it were individually recited herein. All methods described herein may be performed in any suitable order, unless otherwise indicated herein or clearly contradicted by context. Any examples or exemplary language used herein (for example, “such as”), unless otherwise asserted, are intended merely to better illustrate the disclosure and do not apply limitations to the scope of the disclosure. No language in the Description should be construed as indicating any non-claimed element as essential to the practice of the disclosure.

Preferred embodiments of the disclosure are described in this Description, including the best mode known to the inventors for carrying out the disclosure. Variations of these preferred embodiments will become apparent to those skilled in the art upon reading the above descriptions. The inventors expect that skilled practitioners will apply such variations as appropriate, and intend that the disclosure will be embodied otherwise than as specifically described herein. Accordingly, this disclosure includes all modifications and equivalents of the subject matter recited in the claims appended hereto as permitted by applicable law. Moreover, the disclosure encompasses any combination of the above-described elements in all variations thereof unless otherwise indicated in this Description or clearly contradicted by context.

1. A laminated body manufacturing device comprising:
a feed mechanism capable of feeding a plurality of iron core members including a locking iron core member and a non-locking iron core member, the locking iron core member including locking pieces at a plurality of locations of an outer periphery or an inner periphery thereof, and the non-locking iron core member not including the locking pieces;
a receiving member capable of receiving the iron core members fed from the feed mechanism;
a dividing mechanism disposed between the feed mechanism and the receiving member in a conveyance direction of the iron core members, the dividing mechanism controlling feeding of the iron core members to the receiving member; and
a squeeze disposed between the feed mechanism and the dividing mechanism in the conveyance direction, the squeeze laterally supporting the iron core members being fed from the feed mechanism, and the squeeze being capable of conveying the iron core members laterally supported by the squeeze in the conveyance direction inside the squeeze, wherein:
at least one of the iron core members is composed as a block body in which a plurality of plate-shaped core pieces are bonded to one another; and
the dividing mechanism includes:
locking parts that are movable between a locking position, at which the locking parts respectively lock the plurality of locking pieces of the locking iron core member discharged from the squeeze, and a non-locking position, at which the locking parts respectively do not lock the locking pieces, and
an actuating device that moves the locking parts to the locking position and the non-locking position.

2. The laminated body manufacturing device according to claim 1, wherein:
the iron core members are plurally laminated and compose a block core,
one block core or a laminated plurality of block cores composes a motor core, and the block core includes one locking iron core member or a plurality of locking iron core members disposed at a downstream side in the conveyance direction and one non-locking iron core member or a plurality of non-locking iron core members disposed at an upstream side in the conveyance direction.

3. The laminated body manufacturing device according to claim 2, wherein, after the actuating device has moved the locking parts from the locking position to the non-locking position, the actuating device returns the locking parts to the locking position in a period in which the non-locking iron core member is passing through a location on a conveyance path of the iron core members that encompasses the locking position.

4. The laminated body manufacturing device according to claim 1, wherein fastening portions are provided at the plurality of core pieces composing the block body, and the fastening portions are used for the bonding of the block body.

5. The laminated body manufacturing device according to claim 1, further comprising a rotating mechanism that rotates the receiving member about a rotation axis along the conveyance direction.

6. A laminated body manufacturing device comprising:
a squeeze capable of conveying a plurality of iron core members including a locking iron core member and a non-locking iron core member downward, the locking iron core member including locking pieces at a plurality of locations of an outer periphery thereof, and the non-locking iron core member not including the locking pieces;
a feed mechanism disposed at an upstream side of the squeeze in a conveyance direction of the iron core members, the feed mechanism being capable of selectively feeding the locking iron core member and the non-locking iron core member to the squeeze; and
a receiving member capable of receiving the iron core members fed from an end portion at a downstream side of the squeeze in the conveyance direction, wherein:
at least one of the iron core members is composed as a block body in which a plurality of plate-shaped core pieces are bonded to one another; and
the squeeze includes a squeeze upstream portion disposed at the upstream side of the squeeze in the conveyance direction and a squeeze downstream portion disposed at the downstream side of the squeeze in the conveyance direction, the squeeze upstream portion laterally supporting both the locking iron core member and non-locking iron core member passing through an interior of the squeeze, and the squeeze downstream portion laterally supporting the locking pieces of the locking iron core member passing through the interior of the squeeze.

7. A laminated body manufacturing method comprising:
bonding a plurality of plate-shaped core pieces to one another to form a block body;
feeding a plurality of iron core members from a feed mechanism, at least one of the iron core members being composed as the block body, and the plurality of iron core members including a locking iron core member and a non-locking iron core member, the locking iron core member including locking pieces at a plurality of locations of an outer periphery or an inner periphery thereof, and the non-locking iron core member not including the locking pieces;
laterally supporting the iron core members fed from the feed mechanism, including using a squeeze disposed at a downstream side of the feed mechanism in a conveyance direction of the iron core members, the squeeze being capable of conveying the iron core members laterally supported by the squeeze in the conveyance direction inside the squeeze;
selectively supporting the iron core members discharged from the squeeze, including using a dividing mechanism that includes:
locking parts that are movable between a locking position, at which the locking parts respectively lock the plurality of locking pieces of the locking iron core member discharged from the squeeze, and a non-locking position, at which the locking parts respectively do not lock the locking pieces, and
an actuating device that moves the locking parts to the locking position and the non-locking position,
the locking parts disposed at the locking position locking the locking pieces of the locking iron core member for supporting the iron core members;
moving the locking parts from the locking position to the non-locking position for feeding a plurality of the iron core members supported by the dividing mechanism to a receiving member; and
returning the locking parts that have been moved to the non-locking position to the locking position in a period in which the non-locking iron core member is passing through a location on a conveyance path of the iron core members that encompasses the locking position.

8. The laminated body manufacturing method according to claim 7, further comprising rotating the receiving member by a predetermined angle about a rotation axis along the conveyance direction.

9. The laminated body manufacturing method according to claim 7, wherein:
the iron core members are plurally laminated and compose a block core,
one block core or a laminated plurality of block cores composes a motor core, and
the block core includes one locking iron core member or a plurality of locking iron core members disposed at a downstream side in the conveyance direction of the block core and one non-locking iron core member or a plurality of non-locking iron core members disposed at an upstream side in the conveyance direction.

10. A laminated body manufacturing method comprising:
bonding a plurality of plate-shaped core pieces to one another to form a block body;
feeding a plurality of iron core members to a squeeze,
at least one of the iron core members being composed as the block body,
the plurality of iron core members including a locking iron core member and a non-locking iron core member, the locking iron core member including locking pieces at a plurality of locations of an outer periphery thereof, and the non-locking iron core member not including the locking pieces, and
the squeeze including a squeeze upstream portion disposed at an upstream side of the squeeze in a conveyance direction of the iron core members and a squeeze downstream portion disposed at a downstream side of the squeeze in the conveyance direction, the squeeze upstream portion laterally supporting both the locking iron core member and non-locking iron core member passing through an interior of the squeeze, and the squeeze downstream portion laterally supporting the locking pieces of the locking iron core member passing through the interior of the squeeze; and
receiving, at a receiving member,
the locking iron core member that has passed through the squeeze downstream portion or
the locking iron core member that has passed through the squeeze downstream portion and one non-locking iron core member or a plurality of non-locking iron core members supported at an upper face of the locking iron core member.
